(19) United States
(12) Patent Application Publication
(10) Pub. No.: US 2024/0157384 A1
(43) Pub. Date: May 16, 2024

(54) Masking Jig, Film Formation Method, and Film Formation Device

(71) Applicant: TATSUTA ELECTRIC WIRE & CABLE CO., LTD., Osaka (JP)

(72) Inventor: Masaki HIRANO, Kizugawa-shi, Kyoto (JP)

(21) Appl. No.: 18/283,074

(22) PCT Filed: Mar. 23, 2022
(86) PCT No.: PCT/JP2022/013680

§ 371 Date: Sep. 20, 2023

(30) Foreign Application Priority Data
Mar. 24, 2021 (JP) 2021-050241

(51) Int. Cl. B05B 7/14; B05B 12/20; B05D 1/12

(52) U.S. Cl. CPC B05B 7/1481; B05B 12/20; B05D 1/12

(57) ABSTRACT

Provided are a masking jig, a film formation method, and a film formation device that enable efficient formation of a film with consistent quality on the surface of a substrate. A masking jig is used in a thermal spraying method, and includes a body portion. The body portion includes a first surface and a second surface. The second surface is located on a side opposite to the first surface. The body portion has a through hole formed therethrough extending from the first surface to the second surface. The second surface includes inclined surfaces having inclination angles θ1 and θ2 of larger than or equal to 30° and smaller than 90° with respect to the first surface. An open end of the through hole in the second surface is formed in the inclined surfaces.

### TECHNICAL FIELD

The present disclosure relates to a masking jig, a film formation method, and a film formation device.

### BACKGROUND ART

A cold spraying method has conventionally been known as one of the thermal spraying methods. In the cold spraying method, a film formation material is sprayed onto a substrate together with a carrier gas to form a film on the substrate (see, for example, Japanese Patent Laying-Open No. 2017-170369).

Further, in the thermal spraying methods such as the cold spraying method described above, a masking jig disposed on the surface of the substrate is used to define a film formation range (see, for example, Japanese Patent Laying-Open No. 2002-361135). It is possible to define the shape of a film formation region as viewed from above by feeding the film formation material to the surface of the substrate through a through hole formed in the masking jig.

### CITATION LIST

### Patent Literature

PTL 1: Japanese Patent Laying-Open No. 2017-170369

PTL 2: Japanese Patent Laying-Open No. 2002-361135

### SUMMARY OF INVENTION

### Technical Problem

In the thermal spraying methods such as the cold spraying method described above, in a case where the masking jig is used, a film made of the film formation material is also formed on the surface of the masking jig. When the film is formed on the surface of the masking jig, process conditions (film formation conditions) under which the film formation material is fed to the surface of a board through the through hole of the masking jig may consequently change from the initial conditions at the beginning of film formation. As a result, it becomes difficult to stably form a film on the surface of the substrate. Furthermore, in order to make the film formed on the surface of the substrate high in quality, it is necessary to perform processing such as removal of the film formed on the surface of the masking jig at regular intervals. This makes it difficult to efficiently form a film with consistent quality on the surface of the substrate.

It is therefore an object of the present disclosure to provide a masking jig, a film formation method, and a film formation device that enable efficient formation of a film with consistent quality on a surface of a substrate.

### Solution to Problem

A masking jig according to the present disclosure is used in a thermal spraying method, and includes a body portion. The body portion includes a first surface and a second surface. The second surface is located on a side opposite to the first surface. The body portion has a through hole formed therethrough extending from the first surface to the second surface. The second surface includes an inclined surface having an inclination angle of larger than or equal to 30° and smaller than 90° with respect to the first surface. An open end of the through hole in the second surface is formed in the inclined surface.

A film formation method according to the present disclosure includes disposing the masking jig so as to cause the masking jig to face a surface of a substrate. In the disposing, the masking jig is disposed so as to cause the first surface of the masking jig to face the surface of the substrate. The film formation method according to the present disclosure includes spraying, through the through hole of the masking jig, powder as a film formation raw material onto the surface of the substrate by a cold spraying method.

A film formation device according to the present disclosure includes a spray gun including a nozzle, a powder feeding portion, a gas feeding portion, and the masking jig. The powder feeding portion feeds powder as a film formation raw material to the spray gun. The gas feeding portion feeds a working gas to the spray gun. The masking jig is disposed between a substrate and the spray gun.

### Advantageous Effects of Invention

According to the above, it is possible to efficiently form a film with consistent quality on the surface of the substrate.

### BRIEF DESCRIPTION OF DRAWINGS

FIG. 1 is a diagram schematically illustrating a configuration of a film formation device according to the present embodiment.

FIG. 2 is a schematic plan view illustrating a masking jig according to the present embodiment.

FIG. 3 is a schematic side view of the masking jig illustrated in FIG. 2.

FIG. 4 is a schematic plan view illustrating a first modification of the masking jig according to the present embodiment.

FIG. 5 is a schematic side view of the masking jig illustrated in FIG. 4.

FIG. 6 is a schematic plan view illustrating a second modification of the masking jig according to the present embodiment.

FIG. 7 is a schematic side view of the masking jig illustrated in FIG. 6.

FIG. 8 is a flowchart illustrating a film formation method according to the present embodiment.

### DESCRIPTION OF EMBODIMENTS

Hereinafter, embodiments of the present disclosure will be described. Note that the same components are denoted by the same reference numerals to avoid the description from being redundant.

### <Configuration of Film Formation Device>

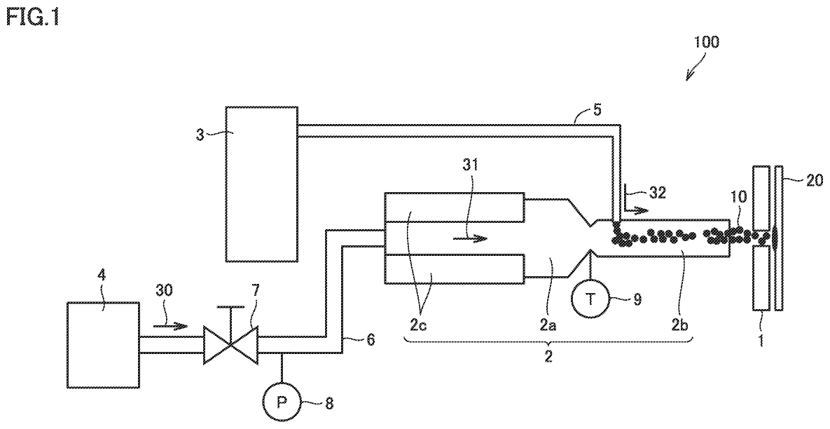

FIG. 1 is a diagram schematically illustrating a configuration of a film formation device 100 according to the present embodiment. Film formation device 100 illustrated in FIG. 1 mainly includes a spray gun 2 including a nozzle 2b, a powder feeding portion 3, a gas feeding portion 4, and a masking jig 1.

Spray gun 2 mainly includes a spray gun body portion 2a, nozzle 2b, a heater 2c, and a temperature sensor 9. Nozzle 2b is connected to a first end of spray gun body portion 2a, the first end being a front end of spray gun body portion 2a. A pipe 6 is connected to a second end of spray gun body portion 2a, the second end being a rear end of spray gun body portion 2a. Pipe 6 is connected to gas feeding portion 4 via a valve 7. Gas feeding portion 4 feeds a working gas to spray gun 2 through pipe 6. It is possible to control, by opening and closing valve 7, a feeding state of the working gas from gas feeding portion 4 to spray gun 2. A pressure sensor 8 is installed in pipe 6. Pressure sensor 8 measures the pressure of the working gas fed from gas feeding portion 4 to pipe 6.

The working gas fed from the second end of spray gun body portion 2a to the inside of spray gun body portion 2a is heated by heater 2c. Heater 2c is disposed adjacent to the second end of spray gun body portion 2a. The working gas flows along an arrow 31 through the inside of spray gun body portion 2a. Temperature sensor 9 is connected to a connection portion between nozzle 2b and spray gun body portion 2a. Temperature sensor 9 measures the temperature of the working gas flowing through the inside of spray gun body portion 2a.

A pipe 5 is connected to nozzle 2b. Pipe 5 is connected to powder feeding portion 3. Powder feeding portion 3 feeds powder as a film formation raw material to nozzle 2b of spray gun 2 through pipe 5.

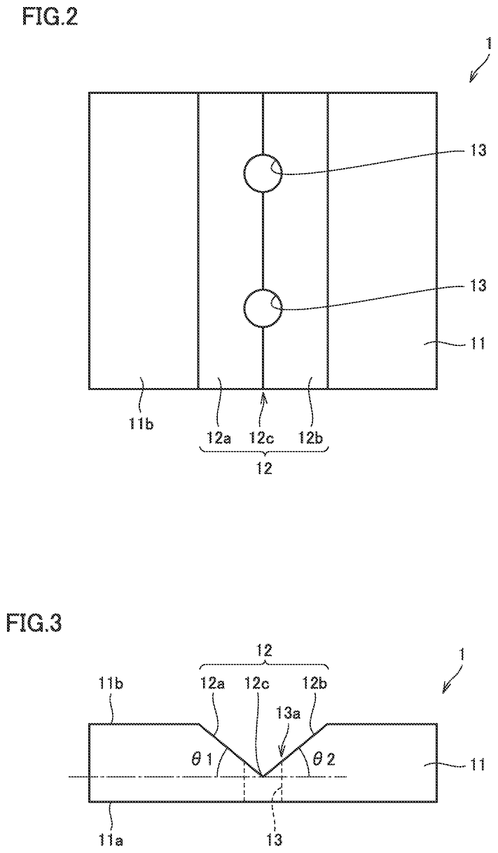

Masking jig 1 is disposed between a substrate 20 and spray gun 2. Masking jig 1 has a through hole 13 (see FIG. 2) formed therein. Through hole 13 defines a film formation region on the surface of substrate 20. A specific configuration of masking jig 1 will be described later.

### <How Film Formation Device Operates>

In film formation device 100 illustrated in FIG. 1, the working gas is fed from gas feeding portion 4 to spray gun 2 through pipe 6 as indicated by an arrow 30. As the working gas, for example, nitrogen, helium, dry air, or a mixture thereof can be used. The working gas has a pressure of about 1 MPa, for example. The working gas has a flow rate of greater than or equal to 300 L/min and less than or equal to 500 L/min, for example. The working gas fed to the second end of spray gun body portion 2a is heated by heater 2c. A temperature to which the working gas is heated is appropriately set in accordance with the composition of the film formation raw material, and may be higher than or equal to 100° C. and lower than or equal to 500° C., for example. The working gas flows from spray gun body portion 2a to nozzle 2b. Powder 10 as the film formation raw material is fed from powder feeding portion 3 to nozzle 2b through pipe 5 as indicated by an arrow 32. As powder 10, for example, nickel powder, tin powder, or a material of a mixture of tin powder and zinc powder can be used. Powder 10 has a particle size of greater than or equal to 1 μm and less than or equal to 50 μm, for example.

Powder 10 fed to nozzle 2b is sprayed from the tip of nozzle 2b toward substrate 20 together with the working gas. Masking jig 1 is disposed on the surface of substrate 20. Powder 10 thus sprayed reaches the surface of substrate 20 through the through hole 13 (see FIG. 2) of masking jig 1. On the surface of substrate 20, a film using sprayed powder 10 as a raw material is formed.

### <Configuration of Masking Jig>

FIG. 2 is a schematic plan view illustrating the masking jig according to the present embodiment. FIG. 3 is a schematic side view of the masking jig illustrated in FIG. 2.

Masking jig 1 illustrated in FIGS. 2 and 3 is used in a cold spraying method that is an example of the thermal spraying method, and includes a body portion 11. Body portion 11 includes a first surface 11a and a second surface 11b. Second surface 11b is located on a side opposite to first surface 11a.

Second surface 11b has a groove 12 formed thereon. An inner peripheral surface of groove 12 includes inclined surfaces 12a and 12b. Groove 12 has a V-shape in cross section along a plane orthogonal to an extending direction of groove 12 as illustrated in FIG. 3. In groove 12, body portion 11 has through hole 13 formed therethrough extending from first surface 11a to second surface 11b. In one groove 12, two through holes 13 are formed spaced apart from each other. The number of the plurality of through holes 13 may be any number greater than or equal to 3. Inclined surface 12a that is a part of the inner peripheral surface of groove 12 has an inclination angle θ1 of larger than or equal to 30° and smaller than 90° with respect to first surface 11a. Inclined surface 12b that is a part of the inner peripheral surface of groove 12 has an inclination angle θ2 of larger than or equal to 30° and smaller than 90° with respect to first surface 11a. Inclination angle θ1 of inclined surface 12a and inclination angle θ2 of inclined surface 12b may be the same as each other or different from each other. An open end 13a of through hole 13 in second surface 11b is formed in inclined surfaces 12a and 12b that are each a part of second surface 11b. From a different point of view, through hole 13 is formed at a bottom portion 12c including a region closest to first surface 11a of the inner peripheral surface of groove 12. That is, open end 13a of through hole 13 is formed in a region including a corner portion where inclined surface 12a and inclined surface 12b are connected, and a part of inclined surface 12a and a part of inclined surface 12b adjacent to the corner portion.

Any material can be used as the material constituting body portion 11 of masking jig 1, and examples of the material may include metal such as stainless steel, steel, and copper, ceramic such as carbon and alumina, and the like.

### <Actions and Effects>

Masking jig 1 according to the present disclosure is used in a thermal spraying method, and includes body portion 11. Body portion 11 includes first surface 11a and second surface 11b. Second surface 11b is located on a side opposite to first surface 11a. Body portion 11 has through hole 13 formed therethrough extending from first surface 11a to second surface 11b. Second surface 11b includes inclined surfaces 12a and 12b having inclination angles θ1 and θ2 of larger than or equal to 30° and smaller than 90° with respect to first surface 11a. Open end 13a of through hole 13 in second surface 11b is formed in inclined surfaces 12a and 12b.

It is therefore possible to perform film formation processing by disposing masking jig 1 on the surface of substrate 20 to be processed so as to cause first surface 11a to face substrate 20 and feeding, by the thermal spraying method, particles that are the film formation raw material to the surface of substrate 20 through the through hole 13 of masking jig 1. At this time, the amount of the film formation raw material deposited on second surface 11b of masking jig 1 can be reduced as compared with a case where second surface 11b of masking jig 1 is flat. It is therefore possible to make the film formation conditions under which the film formation processing is performed on substrate 20 using masking jig 1 consistent for a long period of time, so that the film quality of the film to be formed can be improved. Furthermore, a time (continuous use time) during which the film formation processing can be continuously performed on substrate 20 using masking jig 1 can be made longer.

Here, the upper limit of inclination angles θ1 and θ2 is smaller than 90° and may be 80°, but the upper limit is preferably 60°. In a case where the upper limit of inclination angles θ1 and θ2 is the above-described value, masking jig 1 is easily processed, which reduces the manufacturing cost of masking jig 1, and the amount of the film formation raw material adhering to masking jig 1 can be reduced. The lower limit of inclination angles θ1 and θ2 may be 30° or 40°, but the lower limit is preferably 45°. In a case where the lower limit of inclination angles θ1 and θ2 is the above-described value, the amount of the film formation raw material adhering to masking jig 1 can be sufficiently reduced, and the continuous use time of masking jig 1 can be made longer.

In masking jig 1 described above, at least one groove 12 may be formed in second surface 11b. Groove 12 may have a V-shape in cross section. Inclined surfaces 12a and 12b may be the inner peripheral surface of groove 12.

In this case, it is possible to form masking jig 1 described above with ease by forming groove 12 in second surface 11b and forming through hole 13 in groove 12.

In masking jig 1 described above, through hole 13 may be formed at bottom portion 12c including the region closest to first surface 11a of the inner peripheral surface of groove 12.

In this case, through hole 13 can be made shallow as compared with a case where through hole 13 is formed at a region other than bottom portion 12c of masking jig 1. It is therefore possible to improve the shape accuracy of the film formation region formed on the surface of substrate 20 through the through hole 13.

Film formation device 100 according to the present disclosure includes spray gun 2 including nozzle 2b, powder feeding portion 3, gas feeding portion 4, and masking jig 1. Powder feeding portion 3 feeds powder as the film formation raw material to spray gun 2. Gas feeding portion 4 feeds the working gas to spray gun 2. Masking jig 1 is disposed between substrate 20 and spray gun 2.

In this case, it is possible to reduce, by using masking jig 1 described above, the deposition of the film formation raw material on masking jig 1, and it is therefore possible to make the time during which the film formation process using masking jig 1 can be continuously performed longer.

### <Modification of Masking Jig>

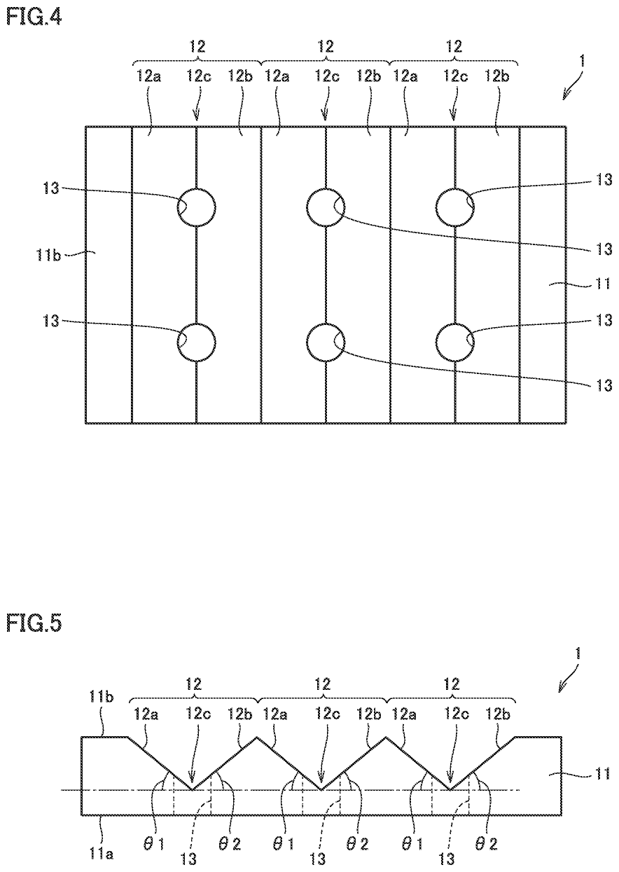

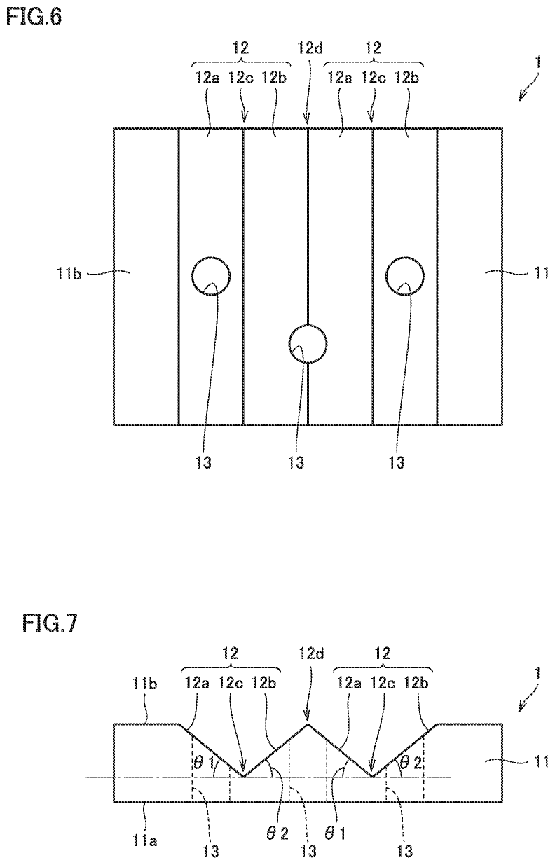

FIG. 4 is a schematic plan view illustrating a first modification of masking jig 1 according to the present embodiment. FIG. 5 is a schematic side view of masking jig 1 illustrated in FIG. 4. FIG. 6 is a schematic plan view illustrating a second modification of masking jig 1 according to the present embodiment. FIG. 7 is a schematic side view of masking jig 1 illustrated in FIG. 6.

Masking jig 1 illustrated in FIGS. 4 and 5 is basically identical in configuration to masking jig 1 illustrated in FIGS. 2 and 3, but is different from masking jig 1 illustrated in FIGS. 2 and 3 in that a plurality of grooves 12 are formed in second surface 11b, and through hole 13 is formed in each groove 12. In masking jig 1 illustrated in FIGS. 4 and 5, the plurality of grooves 12 are formed so as to extend along a first direction (up-down direction in FIG. 4). The plurality of grooves 12 are arranged side by side along a second direction (left-right direction in FIG. 4) orthogonal to the first direction. Through hole 13 is formed in each of the plurality of grooves 12. As illustrated in FIG. 4, two through holes 13 are formed in one groove 12, but the number of through holes 13 formed in one groove 12 may be any number greater than or equal to 3. Through holes 13 are neatly aligned in the left-right direction (second direction) in FIG. 4, but through holes 13 adjacent to each other in the left-right direction may be placed at different positions in the up-down direction (first direction). Each through hole 13 is formed at bottom portion 12c of a corresponding groove 12. The plurality of through holes 13 may have the same size as illustrated in FIG. 4, or alternatively, the plurality of through holes 13 may include through holes 13 having different sizes.

As illustrated in FIG. 5, inclination angles θ1 and θ2 of inclined surfaces 12a and 12b of each groove 12 may be the same among grooves 12, or may be different for each groove 12.

Masking jig 1 having such a configuration can produce the same effects as produced by masking jig 1 illustrated in FIGS. 2 and 3. Furthermore, in masking jig 1 illustrated in FIGS. 4 and 5, forming the plurality of grooves 12 in second surface 11b allows the plurality of through holes 13 to be easily formed. It is therefore possible to form a film at a plurality of places on the surface of substrate 20 by one-time film formation processing using the cold spraying method.

Masking jig 1 illustrated in FIGS. 6 and 7 is basically identical in configuration to masking jig 1 illustrated in FIGS. 2 and 3, but is different from masking jig 1 illustrated in FIGS. 2 and 3 in that a plurality of grooves 12 are formed in second surface 11b, through hole 13 is formed in each groove 12, and the layout of through holes 13 in grooves 12 is different. In masking jig 1 illustrated in FIGS. 6 and 7, two grooves 12 are formed adjacent to each other. Through hole 13 located on the left side in FIG. 6 is formed in one inclined surface 12a of a first groove 12 located on the left side. That is, the open end of through hole 13 is located in inclined surface 12a.

Through hole 13 located at the center in FIG. 6 is formed in a boundary region between two grooves 12. Specifically, through hole 13 is formed in the boundary region including a part of inclined surface 12b of first groove 12 located on the left side, a part of inclined surface 12a of a second groove 12 located on the right side, and a part of a boundary portion between first groove 12 and second groove 12. Through hole 13 located on the right side in FIG. 6 is formed in one inclined surface 12b of second groove 12 located on the right side. That is, the open end of through hole 13 is located in inclined surface 12b. As illustrated in FIG. 6, the positions of the plurality of through holes 13 in the first direction that is the extending direction of grooves 12 are different from each other.

Masking jig 1 having such a configuration can produce the same effects as produced by masking jig 1 illustrated in FIGS. 2 and 3.

Note that, in masking jig 1 described above, a plurality of grooves 12 may be formed all over second surface 11b. Alternatively, as illustrated in FIGS. 4 to 7, a flat portion in which no groove 12 is formed may be formed at both end portions of second surface 11b in the direction orthogonal to the extending direction of grooves 12.

Further, in masking jig 1 described above, inclined surfaces 12a and 12b in which through holes 13 are formed may partially include curved surfaces. Further, inclined surfaces 12a and 12b may have constant inclination angles θ1 and θ2 in their entirety, but may include surfaces having locally different inclination angles θ1 and θ2.

### <Film Formation Method>

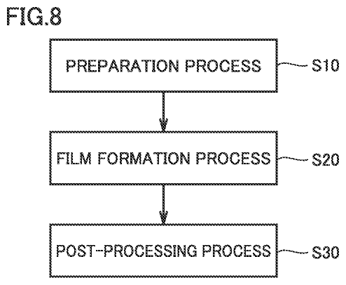

FIG. 8 is a flowchart illustrating a film formation method according to the present embodiment. The film formation method illustrated in FIG. 8 is performed using masking jig 1 and film formation device 100 illustrated in FIGS. 1 to 3, and mainly includes a preparation process (S10), a film formation process (S20), and a post-processing process (S30).

The preparation process (S10) includes a process of disposing masking jig 1 so as to cause masking jig 1 to face the surface of substrate 20 as illustrated in FIG. 1. In the disposing process, masking jig 1 is disposed so as to cause first surface 11a (see FIG. 3) of masking jig 1 to face the surface of substrate 20.

In the film formation process (S20), powder as a film formation raw material is sprayed, through the through hole 13 of masking jig 1, onto the surface of substrate 20 by the cold spraying method using film formation device 100. As a result, a film made of the film formation raw material is formed on the surface of substrate 20.

In the post-processing process (S30), masking jig 1 is removed from the surface of substrate 20. Thereafter, necessary processing such as processing on substrate 20 is performed. Accordingly, a film can be formed on the surface of substrate 20.

In the film formation method described above, the use of masking jig 1 according to the present embodiment allows a reduction in the amount of the film formation raw material adhering to masking jig 1, so that the time during which the film formation process (S20) can be continuously performed can be made longer. Alternatively, the use of masking jig 1 allows an increase in the number of times masking jig 1 can be repeatedly used.

### EXAMPLE

Hereinafter, an example for confirming the effects of the masking jig according to the present disclosure will be described.

### <Sample>

As the masking jig having the configuration illustrated in FIGS. 4 and 5, sample masking jigs having different inclination angles θ1 and θ2 were prepared. Specifically, samples 1, 2, and 3 having inclination angles θ1 and θ2 of 15°, 30°, and 45°, respectively, were prepared. Further, a masking jig having a flat plate shape with no groove formed was also prepared as a sample 4. Each sample was made of stainless steel SUS 304. Each sample had a quadrangular shape as viewed from above, and its size was 42 mm in width×30 mm in length×3 mm in thickness. Through hole had a diameter of 3 mm.

In sample 1, two grooves were formed so as to extend along a longitudinal direction (short-side direction) as viewed from above. In samples 2 and 3, three grooves were formed so as to extend along the longitudinal direction (short-side direction) as viewed from above. Each groove had two through holes formed at its bottom portion. In sample 4, as in sample 3, three pairs of two through holes were formed so as to be aligned along the longitudinal direction.

### <Film Formation Process>

With samples 1 to 4 described above, a film was formed on the surface of a substrate by the cold spraying method. As a film formation raw material, powder made of aluminum was used. The aluminum powder had a spherical shape and had a diameter of 10 μm. The substrate was made of alumina (Al₂O₃). The substrate had a quadrangular shape as viewed from above. The substrate had a size of 42 mm in width×30 mm in length×3 mm in thickness.

As film formation conditions, dry air was used as a working gas, and the working gas had a temperature of 270° C., a flow rate of 400 L/min, and a pressure of about 0.8 MPa. A region where the film formation raw material was sprayed from the film formation device to the surface of the masking jig had a width of 5 mm. Further, on the surface of the masking jig, a rate (sweep rate) at which the region where the film formation raw material is sprayed is moved so as to cover the region where the through hole is formed was set at 5 mm/sec. A film formation range (region where the film formation raw material is sprayed) on the surface of the masking jig had a size of 5 mm in width×30 mm in length. In each sample, the above-described film formation range was set so as to cover one pair of two through holes aligned in the longitudinal direction, and a region 1 where the film formation raw material is sprayed only once was formed in the film formation range. Further, the above-described film formation range was set so as to cover another pair of two through holes, and a region 2 where the film formation raw material is sprayed five times was formed in the film formation range.

After a film was formed on the surface of the substrate using each of samples 1 to 4 under the above-described conditions, the weight (amount) of the film formation raw material adhering to the surface in region 2 of each of samples 1 to 4 was measured. Further, the film thickness of the film formed on the surface of the substrate through region 1 of each of samples 1 to 4 was measured.

### <Result>

Adhesion amount in region 2 of each sample:

The adhesion amount of sample 1 was 142.9 mg, the adhesion amount of sample 2 was 60.9 mg, the adhesion amount of sample 3 was 35.4 mg, and the adhesion amount of sample 4 was 141.9 mg. As described above, sample 1 having inclination angles θ1 and θ2 of 15° was almost equal in adhesion amount to sample 4 having a flat plate shape (having inclination angles θ1 and θ2 of 0°. On the other hand, in samples 2 and 3 having inclination angles θ1 and θ2 of 30° and 45°, respectively, the adhesion amount was greatly reduced as compared with samples 1 and 4. Further, sample 3 that is relatively larger in inclination angles θ1 and θ2 than sample 2 was smaller in adhesion amount than sample 2. This result showed that the masking jig according to the present disclosure is smaller in adhesion amount of the film formation raw material.

Film thickness of film formed on surface of substrate through region 1 of each sample:

A film formed on the substrate using sample 1 had a thickness of 73 μm, a film formed on the substrate using sample 2 had a thickness of 76 μm, a film formed on the substrate using sample 3 had a thickness of 86 μm, and a film formed on the substrate using sample 4 had a thickness of 44 μm. As described above, it showed that in a case where a film is formed on the substrate using the masking jig according to the present disclosure, a film formed under the same conditions can be made thicker than before.

It should be understood that the embodiments disclosed herein are illustrative in all respects and not restrictive. At least two of the embodiments disclosed herein may be combined as long as there is no inconsistency. The scope of the present disclosure is defined in principle by the claims rather than the above description, and the present disclosure is intended to include the claims, equivalents of the claims, and all modifications within the scope.

### REFERENCE SIGNS LIST

1: masking jig, 2: spray gun, 2a: spray gun body portion, 2b: nozzle, 2c: heater, 3: powder feeding portion, 4: gas feeding portion, 5, 6: pipe, 7: valve, 8: pressure sensor, 9: temperature sensor, 10: powder, 11: body portion, 11a: first surface, 11b: second surface, 12: groove, 12a, 12b: inclined surface, 12c: bottom portion, 13: through hole, 13a: open end, 20: substrate, 30, 31, 32: arrow, 100: film formation device

1. A masking jig used in a thermal spraying method, the masking jig comprising a body portion including a first surface and a second surface located on a side opposite to the first surface, wherein
the body portion has a through hole formed therethrough extending from the first surface to the second surface,
the second surface includes an inclined surface having an inclination angle of larger than or equal to 30° and smaller than 90° with respect to the first surface, and
an open end of the through hole in the second surface is formed in the inclined surface.

2. The masking jig according to claim 1, wherein
at least one groove is formed in the second surface,
the groove has a V-shape in cross section, and
the inclined surface is an inner peripheral surface of the groove.

3. The masking jig according to claim 2, wherein
a plurality of the grooves are formed in the second surface so as to extend in a first direction, and are arranged side by side along a second direction orthogonal to the first direction.

4. The masking jig according to claim 2, wherein
the through hole is formed at a bottom portion including a region closest to the first surface of the inner peripheral surface of each of the grooves.

5. A film formation method comprising:
disposing the masking jig according to claim 1 so as to cause the masking jig to face a surface of a substrate, wherein, in the disposing, the masking jig is disposed so as to cause the first surface of the masking jig to face the surface of the substrate; and
spraying, through the through hole of the masking jig, powder as a film formation raw material onto the surface of the substrate by a cold spraying method.

6. A film formation device comprising:
a spray gun including a nozzle;
a powder feeding portion that feeds powder as a film formation raw material to the spray gun;
a gas feeding portion that feeds a working gas to the spray gun; and
the masking jig according to claim 1 disposed between a substrate and the spray gun.
